(19) United States
(12) Patent Application Publication
(10) Pub. No.: US 2024/0301799 A1
(43) Pub. Date: Sep. 12, 2024

(54) AIRFOIL TIP ARRANGEMENT FOR GAS TURBINE ENGINE

(71) Applicant: Raytheon Technologies Corporation, Farmington, CT (US)

(72) Inventor: Brandon W. Spangler, Vernon, CT (US)

(21) Appl. No.: 18/118,365

(22) Filed: Mar. 7, 2023

(51) Int. Cl. F01D 5/20; F01D 5/18

(52) U.S. Cl. CPC F01D 5/20; F01D 5/187; F05D 2240/305; F05D 2240/306; F05D 2240/307; F05D 2260/202

(57) ABSTRACT

A blade for a gas turbine engine, including: an airfoil having a leading edge, a pressure side, a suction side and a trailing edge that extend to a tip of the airfoil; a leading edge cavity located within the airfoil; at least one main body cavity located within the airfoil; pressure side skin core passages located within the airfoil; suction side skin core passages located within the airfoil, the at least one main body cavity being fluidly isolated from the pressure side skin core passages and the suction side skin core passages and the at least one main body cavity being located between the pressure side skin core passages and the suction side skin core passages; a trailing edge feed cavity located within the airfoil; and a tip plenum located proximate to the tip of the airfoil, the tip plenum being fluidly coupled to the at least one main body cavity, wherein the tip plenum is located above the pressure side skin core passages and the trailing edge feed cavity and extends to the trailing edge of the airfoil.

### BACKGROUND

This disclosure relates to cooling schemes for components of a gas turbine engine, and more particularly to a component of a gas turbine engine with internal cooling cavities.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades. In order to protect the rotating blades and stationary vanes from the deleterious effects of the hot combustion gases cooling air is provided to internal cavities of the blades and vanes however and since this cooling air is used to cool the pressure side and suction side of the airfoil or vane it is already significantly heated prior to it reaching a tip of the airfoil or vane.

Accordingly, it is desirable to provide a blades or vanes with internal configurations wherein the cooling air is capable of reaching the tip of the airfoil prior to it being excessively heated.

### BRIEF DESCRIPTION

Disclosed is a blade for a gas turbine engine, including: an airfoil having a leading edge, a pressure side, a suction side and a trailing edge that extend to a tip of the airfoil: a leading edge cavity located within the airfoil; at least one main body cavity located within the airfoil: pressure side skin core passages located within the airfoil; suction side skin core passages located within the airfoil, the at least one main body cavity being fluidly isolated from the pressure side skin core passages and the suction side skin core passages and the at least one main body cavity being located between the pressure side skin core passages and the suction side skin core passages: a trailing edge feed cavity located within the airfoil; and a tip plenum located proximate to the tip of the airfoil, the tip plenum being fluidly coupled to the at least one main body cavity, wherein the tip plenum is located above the pressure side skin core passages and the trailing edge feed cavity and extends to the trailing edge of the airfoil.

In addition to one or more of the features described above, or as an alternative to any of the foregoing embodiments, a tip shelf located in the tip of the airfoil, a portion of the tip plenum being located below the tip shelf, the tip shelf extending to the pressure side of the airfoil.

In addition to one or more of the features described above, or as an alternative to any of the foregoing embodiments, a squealer pocket is located in the tip of the airfoil, the squealer pocket being located proximate to the suction side of the airfoil.

In addition to one or more of the features described above, or as an alternative to any of the foregoing embodiments, the squealer pocket is fluidly coupled to a suction side tip plenum that extends proximate to the suction side of the airfoil, the suction side tip plenum is fluidly coupled to the suction side skin core passages.

In addition to one or more of the features described above, or as an alternative to any of the foregoing embodiments, cooling openings extend from the tip shelf to the tip plenum.

In addition to one or more of the features described above, or as an alternative to any of the foregoing embodiments, an opening is located at the trailing edge of the airfoil, the opening being fluidly coupled to the tip plenum.

In addition to one or more of the features described above, or as an alternative to any of the foregoing embodiments, the blade is a turbine blade.

In addition to one or more of the features described above, or as an alternative to any of the foregoing embodiments, the tip plenum has a rectangular cross-section.

In addition to one or more of the features described above, or as an alternative to any of the foregoing embodiments, the at least one main body cavity is a pair of main body cavities.

In addition to one or more of the features described above, or as an alternative to any of the foregoing embodiments, a wall is located between a top portion of the pressure side skin core passages and a bottom of the tip plenum, the wall being angularly arranged with respect to a horizontal line extending from the airfoil.

In addition to one or more of the features described above, or as an alternative to any of the foregoing embodiments, the wall is angularly arranged with an angle between 30 and 70 degrees with respect to the horizontal line.

In addition to one or more of the features described above, or as an alternative to any of the foregoing embodiments, the leading edge cavity, the at least one main body cavity, pressure side skin core passages, suction side skin core passages, and trailing edge feed cavity are configured to have angled surfaces such that the pressure side skin core passages, suction side skin core passages are generally triangular in shape and are interwoven or partially inserted in between complementary angled surfaces of the at least one main body cavity and trailing edge feed cavity.

In addition to one or more of the features described above, or as an alternative to any of the foregoing embodiments, the at least one main body cavity is a pair of main body cavities.

Also disclosed is a gas turbine engine, including: a fan section; a compressor section: a combustor section: and a turbine section, the turbine section having a plurality blades, each of the plurality of blades having an airfoil, the airfoil having a leading edge, a pressure side, a suction side and a trailing edge that extend to a tip of the airfoil: a leading edge cavity located within the airfoil: at least one main body cavity located within the airfoil: pressure side skin core passages located within the airfoil; suction side skin core passages located within the airfoil, the at least one main body cavity being fluidly isolated from the pressure side skin core passages and the suction side skin core passages and the at least one main body cavity being located between the pressure side skin core passages and the suction side skin core passages: a trailing edge feed cavity located within the airfoil: and a tip plenum located proximate to the tip of the airfoil, the tip plenum being fluidly coupled to the at least one main body cavity, wherein the tip plenum is located above the pressure side skin core passages and the trailing edge feed cavity and extends to the trailing edge of the airfoil.

In addition to one or more of the features described above, or as an alternative to any of the foregoing embodiments, a tip shelf is located in the tip of the airfoil, a portion of the tip plenum being located below the tip shelf, the tip shelf extending to the pressure side of the airfoil.

In addition to one or more of the features described above, or as an alternative to any of the foregoing embodiments, a squealer pocket is located in the tip of the airfoil, the squealer pocket being located proximate to the suction side of the airfoil.

In addition to one or more of the features described above, or as an alternative to any of the foregoing embodiments, the squealer pocket is fluidly coupled to a suction side tip plenum that extends proximate to the suction side of the airfoil, the suction side tip plenum is fluidly coupled to the suction side skin core passages.

In addition to one or more of the features described above, or as an alternative to any of the foregoing embodiments, a wall is located between a top portion of the pressure side skin core passages and a bottom of the tip plenum, the wall being angularly arranged with respect to a horizontal line extending from the airfoil.

In addition to one or more of the features described above, or as an alternative to any of the foregoing embodiments, the wall is angularly arranged with an angle between 30 and 70 degrees with respect to the horizontal line.

Also disclosed is a method for cooling a tip of an airfoil of a blade of a gas turbine engine, including: providing cooling air to a tip plenum located proximate to the tip of the airfoil, the tip plenum being fluidly coupled to at least one main body cavity, the at least one main body cavity being isolated from pressure side skin core passages and suction side skin core passages and the at least one main body cavity being located between the pressure side skin core passages and the suction side skin core passages, wherein the tip plenum is located above the pressure side skin core passages and a trailing edge feed cavity and extends to a trailing edge of the airfoil.

### BRIEF DESCRIPTION OF THE DRAWINGS

The following descriptions should not be considered limiting in any way. With reference to the accompanying drawings, like elements are numbered alike:

FIG. 1 is a schematic, partial cross-sectional view of a gas turbine engine:

FIG. 2 is a view of a portion of a turbine section of the gas turbine engine illustrated in FIG. 1:

FIG. 3 is a cross-sectional view of a turbine blade in accordance with the present disclosure:

FIG. 3A is a cross-sectional view of a turbine blade in accordance with the present disclosure;

FIG. 4 is a view along lines 4-4 of FIGS. 3 and 3A:

FIG. 5 is a view along lines 5-5 of FIGS. 3 and 3A:

FIG. 6 is a view along lines 6-6 of FIGS. 3 and 3A:

FIG. 7 is a view of an alternative embodiment of the present disclosure along lines 5-5 of FIGS. 3 and 3A:

FIG. 8 is another view along lines 6-6 of FIGS. 3 and 3A: and

FIG. 9 is a view of an alternative embodiment of the present disclosure along lines 6-6 of FIGS. 3 and 3A.

### DETAILED DESCRIPTION

A detailed description of one or more embodiments of the disclosed apparatus and method are presented herein by way of exemplification and not limitation with reference to the FIGS.

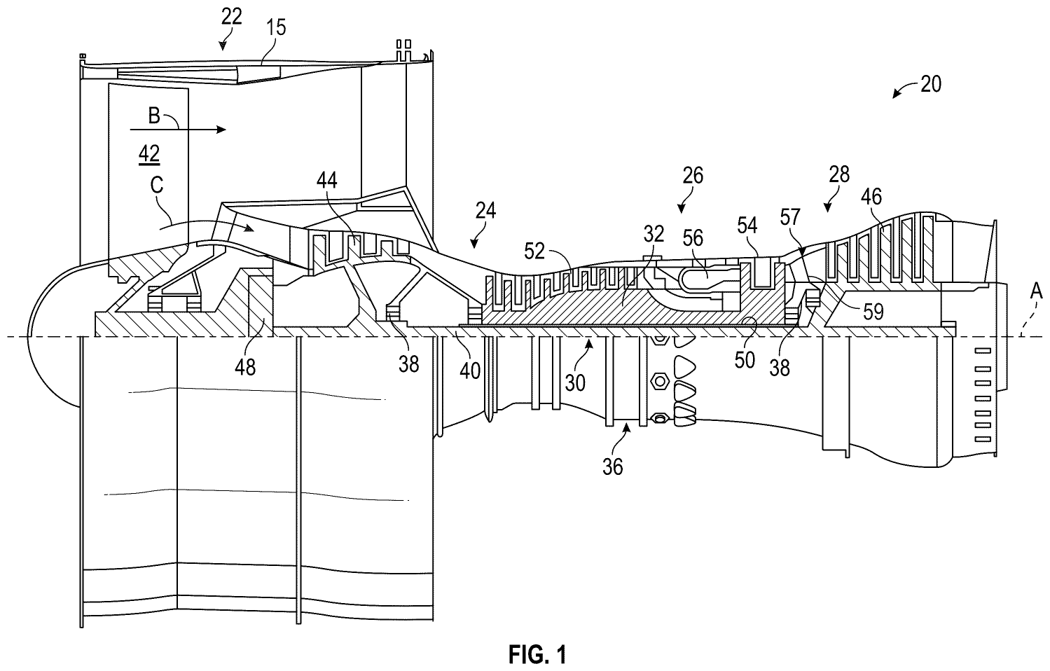

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first or low pressure compressor 44 and a first or low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second or high pressure compressor 52 and a second or high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

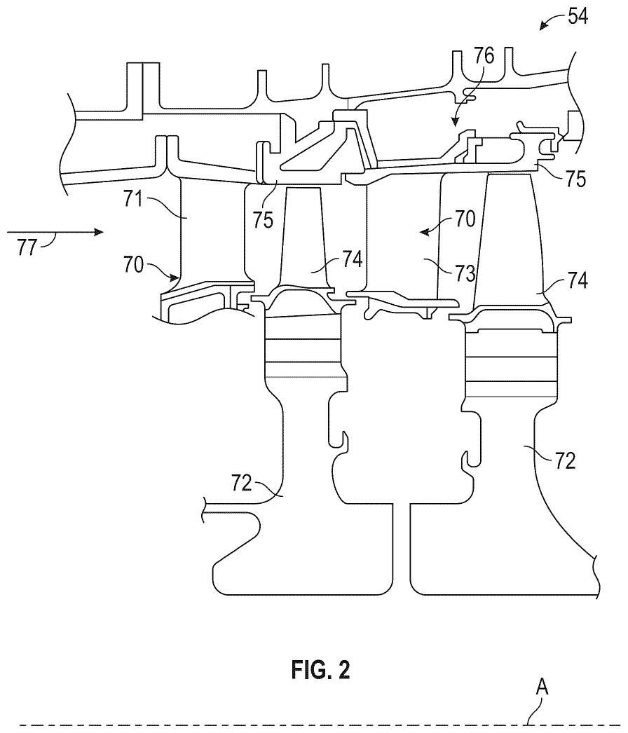

The engine 20 in one example is a high-bypass geared aircraft engine. It is also understood, that the engine 20 illustrated in FIGS. 1 and 2 is merely exemplary and the present disclosure is contemplated for use with any type of gas turbine engine (geared or otherwise).

FIG. 2 illustrates a portion of the high pressure turbine (HPT) 54. FIG. 2 also illustrates a high pressure turbine stage vanes 70 one of which (e.g., a first stage vane 71) is located forward of a first one of a pair of turbine disks 72 each having a plurality of turbine blades 74 secured thereto. The turbine blades 74 rotate proximate to blade outer air seals (BOAS) 75 which are located aft of the first stage vane 71. The other vane 70 is located between the pair of turbine disks 72. This vane 70 may be referred to as the second stage vane 73. As used herein the first stage vane 71 is the first vane of the high pressure turbine section 54 that is located aft of the combustor section 26 and the second stage vane 73 is located aft of the first stage vane 71 and is located between the pair of turbine disks 72. In addition, blade outer air seals (BOAS) 75 are disposed between the first stage vane 71 and the second stage vane 73. The high pressure turbine stage vanes 70 (e.g., first stage vane 71 or second stage vane 73) are one of a plurality of vanes 70 that are positioned circumferentially about the axis A of the engine in order to provide a stator assembly 76. Hot gases from the combustor section 26 flow through the turbine in the direction of arrow 77. Although a two-stage high pressure turbine is illustrated other high pressure turbines are considered to be within the scope of various embodiments of the present disclosure.

The high pressure turbine (HPT) is subjected to gas temperatures well above the yield capability of its material. In order to mitigate such high temperature detrimental effects, surface film-cooling is typically used to cool the blades and vanes of the high pressure turbine. Surface film-cooling is achieved by supplying cooling air from the cold backside through cooling holes drilled on the high pressure turbine components. Cooling holes are strategically designed and placed on the vane and turbine components in-order to maximize the cooling effectiveness and minimize the efficiency penalty.

In addition, internal cooling passageways and interconnecting cooling openings or crossovers are provided to allow for cooling air flow within the blades and vanes of the high pressure turbine.

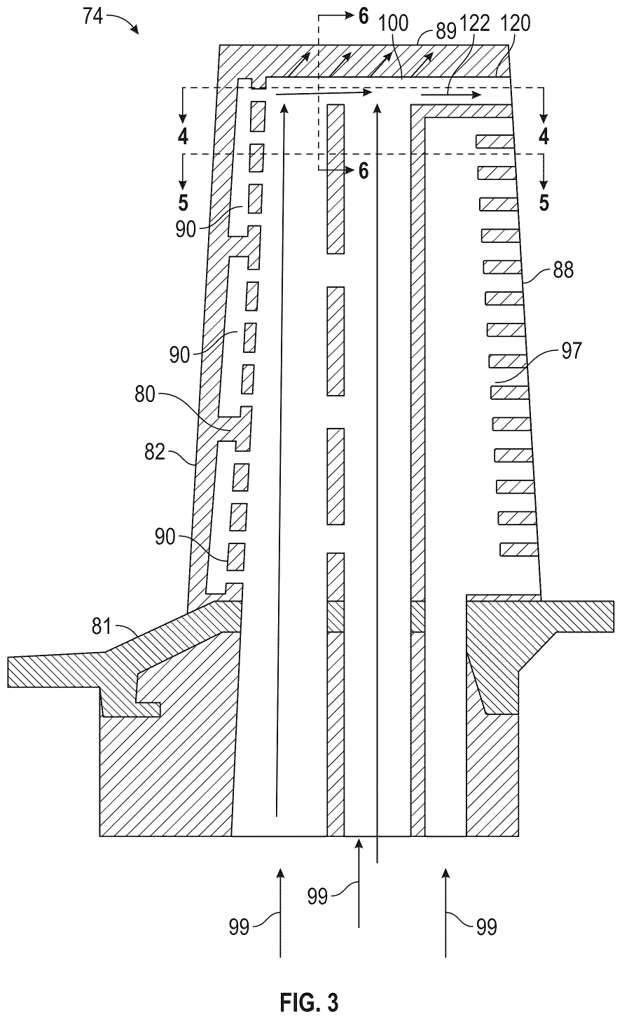

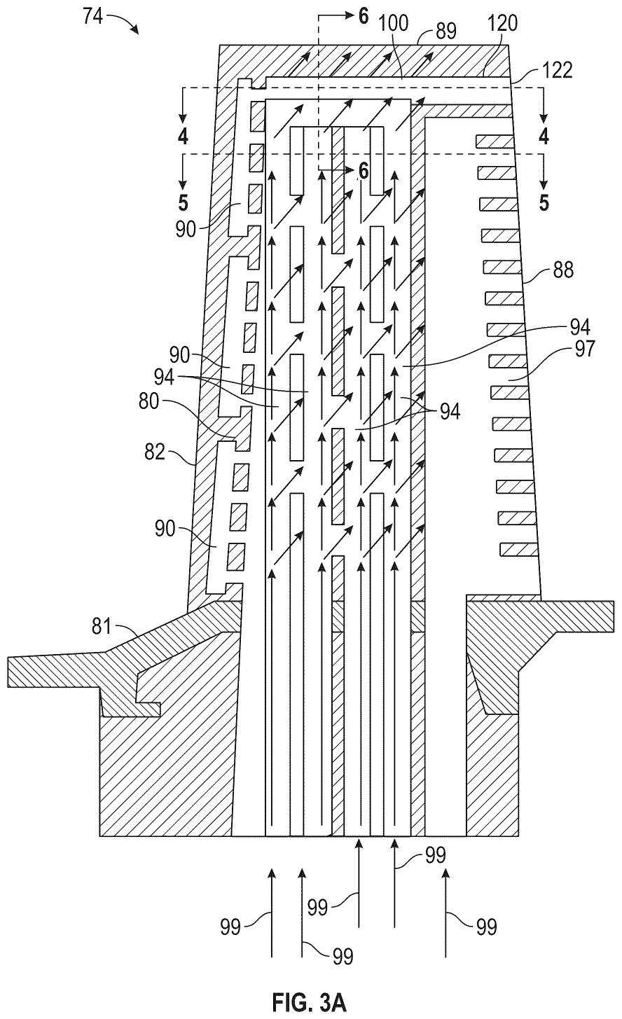

Referring now to at least FIGS. 3-6, a portion of an airfoil 80 of a turbine blade 74 is illustrated in accordance with the present disclosure. Although, a turbine blade is illustrated it is understood that various embodiments of the present disclosure may be applied to other rotating blades employed in the engine 20. The airfoil 80 extends from a platform 81 of the turbine blade 74. An external wall of the airfoil 80 defines an external surface of the airfoil 80 having a leading edge 82, a pressure side 84, a suction side 86 and a trailing edge 88 of the airfoil 80 and extends to a tip 89 of the airfoil 80. The airfoil 80 also has a plurality of internal cooling cavities which include a leading edge cavity 90, main body cavities 92, pressure side skin core passages 94, suction side skin core passages 96, and a trailing edge feed cavity 97. These cavities and passages are provided with cooling air through cooling air supplied to bottom portions of the cavities and passages as illustrated in at least FIGS. 3 and 3A by arrows 99. The airfoil 80 may have only a single main body cavity 92 or at least two main body cavities 92 as illustrated.

The airfoil 80 also has a squealer pocket 98 and a tip plenum 100 each being located proximate to the tip 89 of the airfoil 80. The squealer pocket 98 is located proximate to the suction side 86 and the tip plenum 100 is located proximate to the pressure side 84. The squealer pocket 98 and tip plenum 100 each extend axially along a portion of the airfoil 80. The tip plenum 100 as it extends toward the trailing edge 88 is located proximate to both the suction side 86 and the pressure side 84 of the airfoil 80. Cooling airflow from the suction side skin core passages 96 is provided to the squealer pocket 98 as the squealer pocket 98 is in fluid communication with the suction side skin core passages 96.

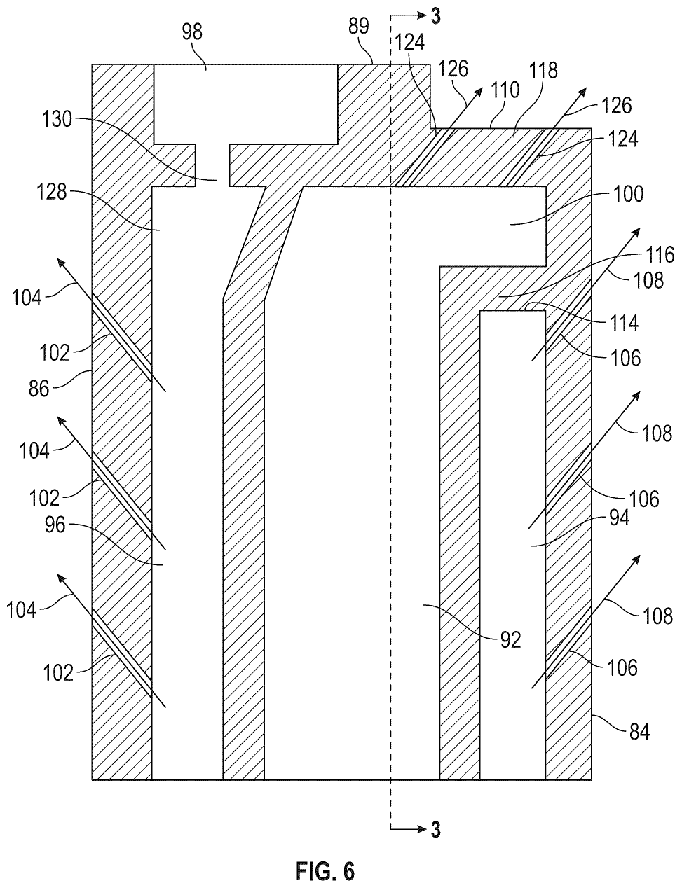

In some embodiments, the fluid communication between the suction side skin core passages 96 and the squealer pocket 98 is the only discharge of the fluid within the suction side skin core passages 96. In other embodiments, the suction side skin core passages 96 also provide cooling air to the suction side 86 via cooling holes 102 that are in fluid communication with the suction side skin core passages 96. This is illustrated by arrows 104 illustrated in at least FIG. 6. The pressure side skin core passages 94 also provide cooling air to the pressure side 84 via cooling holes 106 that are in fluid communication with the pressure side skin core passages 94. This is illustrated by arrows 108 illustrated in at least FIG. 6. The airfoil tip 89 also includes a tip shelf 110.

Some multiwall airfoil designs have relied on pressure side cooling passages 94 and suction side cooling passages 96 to cool the airfoil tip 89 via the tip plenum 100. However, because this air has already been used to cool the pressure side cooling passages 94 and suction side cooling passages 96, this air has been heated by the external surfaces of the airfoil 80. This heating of the cooling air by the external surfaces of the airfoil can be on the order of several hundred degrees. As such, the cooling air may be significantly heated by the external surface prior to it reaching the tip 89 of the airfoil 80. In addition and since tip plenums are typically the end of the road for the cooling air before out of exiting cooling holes, the mach numbers of the cooling air in the tip plenum can be pretty low, resulting in low heat transfer coefficients.

The present disclosure incorporates a tip plenum 100 that is connected to the main body cavities 92 as opposed to the pressure side skin core passages 94 and suction side skin core passages 96. In addition, the main body cavity or cavities 92 are isolated thermally and fluidly from the pressure side cooling passages 94 and suction side cooling passages 96. In other words, the tip plenum 100 is only provided with cooling air from the main body cavity or cavities 92. As such, the cooling air provided to the tip plenum 100 from the main body cavities 92 is insulated from external heated surfaces acting on the pressure side skin core passages 94 and the suction side skin core passages 96 thus resulting in very little heat up of the cooling air in the main body cavities 92 by the external surfaces of the airfoil 80 prior to it reaching the tip plenum 100. In addition, interior walls 112 of the airfoil 80 further insulate the main body cavities 92 from the pressure side skin core passages 94 and the suction side skin core passages 96. These interior walls 112 also fluidly isolate the main body cavities 92 from the pressure side skin core passages 94 and the suction side skin core passages 96. In one non-limiting embodiment, the tip plenum 100 has a rectangular cross-section. Of course, other cross-section configurations are contemplated to be within the scope of the present disclosure.

In addition and since the pressure side skin core passages 94 and the suction side skin core passages 96 are isolated from the tip plenum 100, the pressure side skin core passages 94 and the suction side skin core passages 96 can be configured to optimize heat transfer for cooling the pressure side 84 and the suction side 86 instead of balancing the pressure side 84 and the suction side 86 heat transfer with tip cooling air heat up.

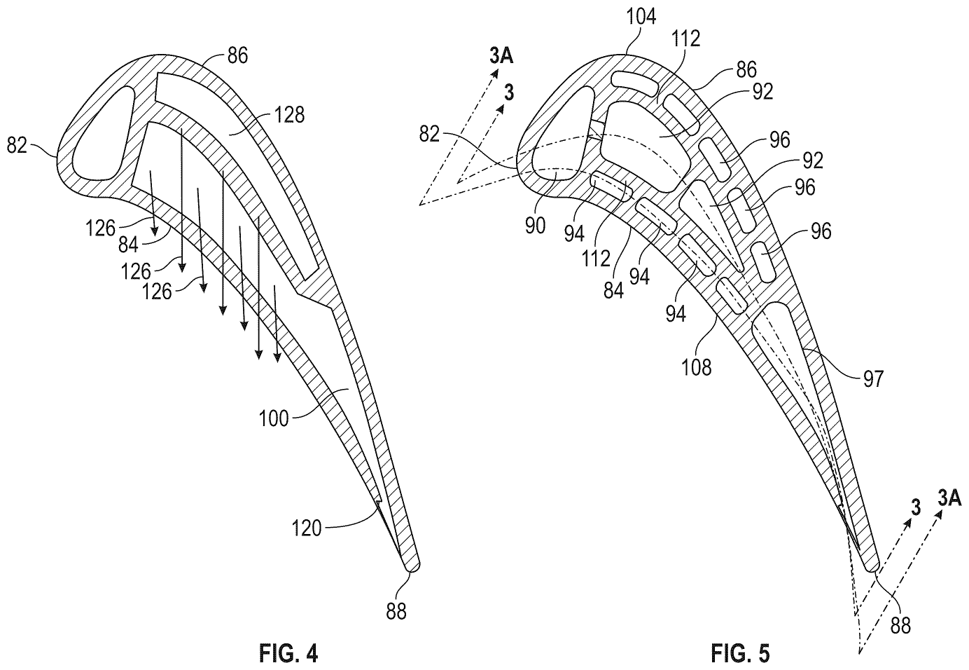

As such, the tip plenum 100 is fed from at least one main body cavity 92 that is insulated from the pressure side skin core passages 94 and the suction side skin core passages 96. In one non-limiting embodiment, the tip plenum is fed by only a single main body cavity 92 or alternatively at least two main body cavities 92. Of course, other numbers of main body cavities 92 are contemplated to be within the scope of the present disclosure. As illustrated in at least FIGS. 4 and 6, the tip plenum 100 is located below the airfoil tip 89 and the tip shelf 110. Portions of the tip plenum 100 are also located above a top portion 114 of the pressure side skin core passages 94. For example and as illustrated in at least FIG. 6, a wall 116 is located between the top portion 114 of the pressure side skin core passages 94 and portions of the tip plenum 100. Also a wall 118 of the airfoil 80 is also located between portions of the tip plenum 100 and the tip shelf 110. The tip plenum 100 also extends towards the trailing edge 88 of the airfoil 80. In one embodiment, the tip plenum 100 extends all the way to the trailing edge 88 of the airfoil 80 such that airflow through the tip plenum 100 exits at an opening 120 illustrated by at least arrow 122.

The tip plenum 100 which is fed cooling air from at least one main body cavity 92 drags this cooling air across nearly the entire tip 89 of the airfoil 80 extending proximate to the pressure side 84, resulting in high heat transfer. In addition and since there is extra airflow out of the tip plenum 100 through the opening 120 at the trailing edge 88, this pulls extra airflow across the tip 89 at higher mach numbers and heat transfer coefficients thus improving cooling of the tip 89 of the airfoil 80.

The tip plenum 100 is also in fluid communication with the tip shelf 110 via cooling openings 124 such that cooling air is provided to the tip shelf 110 from the tip plenum 100, which is insulated from the pressure side skin core passages 94 and the suction side skin core passages 96. This airflow is at least illustrated by arrows 126. As such, the cooling air fed to the tip shelf 110 via the cooling holes 124 also has very little heat build up.

In addition and in the present disclosure, the squealer pocket 98 is in fluid communication with the suction side skin core passages 96 via a suction side tip plenum 128 that is in fluid communication with the suction side skin core passages 96 and passages 130 that provide fluid communication between the squealer pocket 98 and the suction side tip plenum 128. Thus, the squealer pocket 98 is fed separately from the suction side skin core passages 96. In addition and since the tip plenum 100 is located proximate to the tip 89, the suction side plenum 128 which is adjacent to the tip plenum 100 is much smaller resulting in higher heat transfer. As illustrated, the squealer pocket 98 is located proximate to the suction side 86 of the airfoil 80. The cooling air fed to the suction side squealer pocket 98 also provides cooling to the tip 89 of the airfoil 80 further reducing areas of the tip 89 that are uncooled. This direct fluid communication between the suction side skin core passages 96 and the squealer pocket 98 can help position the suction side skin core passages 96 when forming the core that is used for forming the airfoil 80. As is known in the related arts, the core is configured to have the shape of the internal cavities and the material of the airfoil 80 is positioned about the core as is known in the related arts and once the airfoil 80 is formed, the core is removed thereafter leaving the cavities and passages defined by the core.

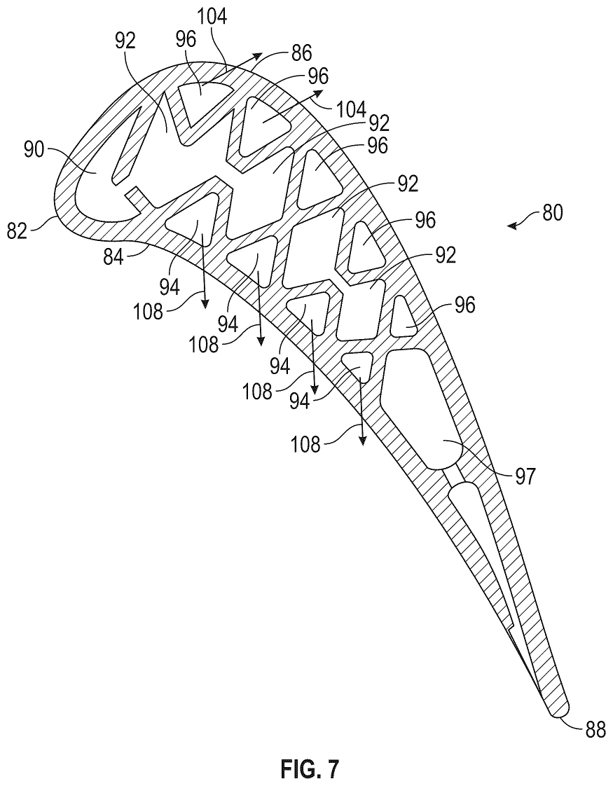

Referring now to FIG. 7 an alternative embodiment of the present disclosure is illustrated. The view in FIG. 7 is similar to the view illustrated in FIG. 5 however, the leading edge cavity 90, main body cavities 92, pressure side skin core passages 94, suction side skin core passages 96, and trailing edge feed cavity 97 may be configured to have angled surfaces such that the pressure side skin core passages 94, suction side skin core passages 96 are generally triangular in shape and are interwoven or partially inserted in between complementary angled surfaces of the main body cavities 92 and trailing edge feed cavity 97. For example and in one non-limiting embodiment, at least some portions of the main body cavities 92 may have a generally diamond shape.

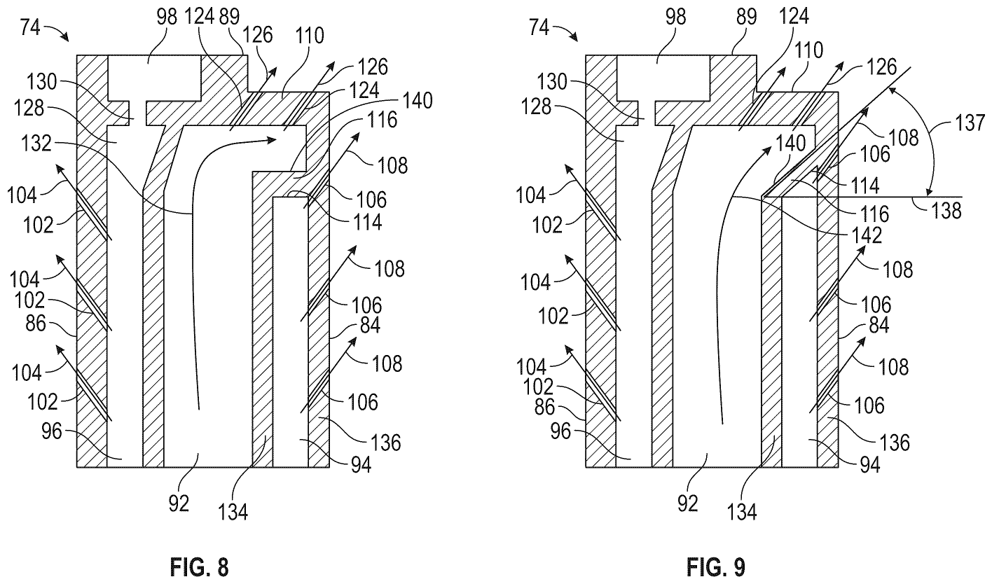

Referring now to FIGS. 8 and 9, yet another alternative embodiment of the present disclosure is illustrated. FIG. 8 is a similar view to FIG. 6 where the cooling airflow in the main body cavity 92 is illustrated by arrow 132. As illustrated, the airflow has to turn 90 degrees to enter the tip plenum 100. This turn may increase a pressure drop and likelihood of flow separation. In addition, the wall 116 located between the top portion 114 of the pressure side skin core passages 94 and portions of the tip plenum 100 may create a stiff box structure, which may result in higher stresses from between the colder inner wall 134 and the hotter outer wall 136.

Referring now to FIG. 9, the wall 116 separating the top portion 114 of the pressure side skin core passages 94 and a bottom portion 140 of the tip plenum 100 is angled. The angle of the wall 116 may be anywhere between 30 and 70 degrees From a horizontal line 138 extending from the airfoil 80. Of course, other angles are contemplated to be within the scope of the present disclosure. In addition, the top 114 of the pressure side skin core passages 94 and the bottom portion 140 of the tip plenum 100 is angled to correspond to the angle of wall 116. This angled surface allows the cooling airflow in the main body cavity 92, as illustrated by arrow 142, to turn less than 90 degrees to enter the tip plenum 100. This lesser turn may result in better flow quality, less pressure drop, and better fill of the tip plenum 100. The angled wall 116 also provides a compliant flexible structure resulting in lower stresses between the colder inner wall 134 and the hotter outer wall 136. In addition and by providing the top portion 114 of the pressure side skin core passages 94 with an angled surface, the cooling hole opening 106 located closest to the top portion 114 of the pressure side skin core passages 94 is able to be closer to the tip 89 and/or the tip shelf 110 of the airfoil 80 thus allowing these cooling holes 106 on the pressure side 84 to be close to the tip 89 and the tip shelf 110 of the airfoil 80 as opposed to the design of the wall 114 illustrated in FIGS. 6 and 8.

In accordance with various embodiments of the present disclosure, the main body cavities 92 of a multiwall airfoil design are protected from external heat loads by the pressure side and suction side skin core cooling cavities 94, 96, thereby significantly reducing the heat up of the cooling air by several hundred degrees. Therefore and by exclusively connecting the tip plenum 100 to the main body cavities 92, colder air or unheated air is provided to the tip plenum 100.

The angled wall 116 in the alternative embodiment of FIG. 9 reduces the amount of turning that the cooling air has to do to enter the tip plenum 100 from the main body cavities 92, resulting in better flow quality, tip plenum cavity fill, and less pressure drop. In addition, the angled wall 116 provides a compliant, flexible structure between the colder inner wall 134 and the hotter outer wall 136, resulting in less stress from the thermal fight between the colder inner wall 134 and the hotter outer wall 136.

In addition and by cooling the tip 89 of the airfoil 80 with air from the main body cavities 92 instead of the pressure side skin core passages 94 and the suction side skin core passages 96, the heat transfer along the pressure and suction sides 84, 86 of the airfoil 80 can be optimized for cooling the pressure and suction sides 84, 86, instead of having to balance the cooling of the pressure and suction sides 84, 86 with the tip cooling air heat up.

Still further and by incorporating a squealer pocket 98 that is connected to the suction side skin core cooling cavities 96 this provides an exit for the cooling air travelling through the suction side skin core cavities 96, maintaining high mach numbers in the suction side skin core cavities 96. In addition, it provides an additional source of cooling for the tip 89 and reduces the size of uncooled tip mass.

Still further and since the squealer pocket 98 prints outside the airfoil 80 and can be held onto by the core and wax dies used to form the airfoil 80, connecting the suction side skin core to the squealer pocket 98 provides a way to maintain the suction side cavity 96 position during the casting process, resulting in better wall control.

The term “about” is intended to include the degree of error associated with measurement of the particular quantity based upon the equipment available at the time of filing the application. For example, “about” can include a range of ×8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A blade for a gas turbine engine, comprising:
an airfoil having a leading edge, a pressure side, a suction side and a trailing edge that extend to a tip of the airfoil;
a leading edge cavity located within the airfoil:
at least one main body cavity located within the airfoil;
pressure side skin core passages located within the airfoil:
suction side skin core passages located within the airfoil, the at least one main body cavity being fluidly isolated from the pressure side skin core passages and the suction side skin core passages and the at least one main body cavity being located between the pressure side skin core passages and the suction side skin core passages:
a trailing edge feed cavity located within the airfoil; and
a tip plenum located proximate to the tip of the airfoil, the tip plenum being fluidly coupled to the at least one main body cavity, wherein the tip plenum is located above the pressure side skin core passages and the trailing edge feed cavity and extends to the trailing edge of the airfoil.

2. The blade as in claim 1, further comprising a tip shelf located in the tip of the airfoil, a portion of the tip plenum being located below the tip shelf, the tip shelf extending to the pressure side of the airfoil.

3. The blade as in claim 2, further comprising a squealer pocket located in the tip of the airfoil, the squealer pocket being located proximate to the suction side of the airfoil.

4. The blade as in claim 3, wherein the squealer pocket is fluidly coupled to a suction side tip plenum that extends proximate to the suction side of the airfoil, the suction side tip plenum is fluidly coupled to the suction side skin core passages.

5. The blade as in claim 2, further comprising cooling openings extending from the tip shelf to the tip plenum.

6. The blade as in claim 1, further comprising an opening located at the trailing edge of the airfoil, the opening being fluidly coupled to the tip plenum.

7. The blade as in claim 1, wherein the blade is a turbine blade.

8. The blade as in claim 1, wherein the tip plenum has a rectangular cross-section.

9. The blade as in claim 1, wherein the at least one main body cavity is a pair of main body cavities.

10. The blade as in claim 1, wherein a wall is located between a top portion of the pressure side skin core passages and a bottom of the tip plenum, the wall being angularly arranged with respect to a horizontal line extending from the airfoil.

11. The blade as in claim 10, wherein the wall is angularly arranged with an angle between 30 and 70 degrees with respect to the horizontal line.

12. The blade as in claim 1, wherein the leading edge cavity, the at least one main body cavity, pressure side skin core passages, suction side skin core passages, and trailing edge feed cavity are configured to have angled surfaces such that the pressure side skin core passages, suction side skin core passages are generally triangular in shape and are interwoven or partially inserted in between complementary angled surfaces of the at least one main body cavity and trailing edge feed cavity.

13. The blade as in claim 12, wherein the at least one main body cavity is a pair of main body cavities.

14. A gas turbine engine, comprising:
a fan section:
a compressor section:
a combustor section; and
a turbine section, the turbine section having a plurality blades, each of the plurality of blades having an airfoil, the airfoil having a leading edge, a pressure side, a suction side and a trailing edge that extend to a tip of the airfoil:
a leading edge cavity located within the airfoil:
at least one main body cavity located within the airfoil;
pressure side skin core passages located within the airfoil;
suction side skin core passages located within the airfoil, the at least one main body cavity being fluidly isolated from the pressure side skin core passages and the suction side skin core passages and the at least one main body cavity being located between the pressure side skin core passages and the suction side skin core passages:
a trailing edge feed cavity located within the airfoil; and
a tip plenum located proximate to the tip of the airfoil, the tip plenum being fluidly coupled to the at least one main body cavity, wherein the tip plenum is located above the pressure side skin core passages and the trailing edge feed cavity and extends to the trailing edge of the airfoil.

15. The gas turbine engine as in claim 14, further comprising a tip shelf located in the tip of the airfoil, a portion of the tip plenum being located below the tip shelf, the tip shelf extending to the pressure side of the airfoil.

16. The gas turbine engine as in claim 15, further comprising a squealer pocket located in the tip of the airfoil, the squealer pocket being located proximate to the suction side of the airfoil.

17. The gas turbine engine as in claim 16, wherein the squealer pocket is fluidly coupled to a suction side tip plenum that extends proximate to the suction side of the airfoil, the suction side tip plenum is fluidly coupled to the suction side skin core passages.

18. The gas turbine engine as in claim 16, wherein a wall is located between a top portion of the pressure side skin core passages and a bottom of the tip plenum, the wall being angularly arranged with respect to a horizontal line extending from the airfoil.

19. The gas turbine engine as in claim 18, wherein the wall is angularly arranged with an angle between 30 and 70 degrees with respect to the horizontal line.

20. A method for cooling a tip of an airfoil of a blade of a gas turbine engine, comprising:
providing cooling air to a tip plenum located proximate to the tip of the airfoil, the tip plenum being fluidly coupled to at least one main body cavity, the at least one main body cavity being isolated from pressure side skin core passages and suction side skin core passages and the at least one main body cavity being located between the pressure side skin core passages and the suction side skin core passages, wherein the tip plenum is located above the pressure side skin core passages and a trailing edge feed cavity and extends to a trailing edge of the airfoil.
